(19) United States
(12) Patent Application Publication
(10) Pub. No.: US 2011/0202187 A1
(43) Pub. Date: Aug. 18, 2011

(54) Lubrication Management

(75) Inventor: Ian Bowmer, Epworth (GB)

(73) Assignee: Bel-Ray Company, Inc., Farmingdale, NJ (US)

(21) Appl. No.: 12/707,144

(22) Filed: Feb. 17, 2010

(51) Int. Cl. G05D 7/06

(52) U.S. Cl. 700/283

(57) ABSTRACT

In methods of and apparatus for managing lubrication of equipment, particulars of equipment requiring lubrication are stored on a computer-readable storage medium. The particulars include at least a desired frequency of scheduled lubrication. A computer provides from the stored particulars a report of scheduled lubrication due. The computer receives information of a specific lubrication having been carried out. The stored particulars are updated to include at least one of when the specific lubrication was carried out and when the specific lubrication is next due in accordance with the desired frequency. In other methods, the report is received, specific lubrication is carried out, and the information of a specific lubrication having been carried out is returned to the computer.

### FIELD OF THE INVENTION

The invention relates to the lubrication of equipment, and more especially to methods and systems for monitoring and managing regular lubrication.

### BACKGROUND OF THE INVENTION

Most industrial equipment requires regular lubrication in order to ensure that it remains in good working order. However, maintaining the necessary records and procedures to ensure that maintenance personnel know what equipment needs lubricating, and when, and how, and with what lubricant, can be a significant burden. This can be an especially significant issue in industries such as food production, where regulatory inspectors may require detailed records to show, in particular, that proper food-grade lubricants are being used, and in proper quantities.

There is therefore a continuing need for a reliable, user friendly system for tracking when lubrication is due, and whether it has in fact been carried out.

### BRIEF SUMMARY OF THE INVENTION

Various aspects of the invention provide methods, systems, and computer programs for achieving, at least in part, some or all of the objects of the invention.

### BRIEF DESCRIPTION OF THE DRAWINGS

The above and other aspects, features and advantages of the present invention will be apparent from the following more particular description thereof, presented in conjunction with the following drawings wherein:

FIG. 1 is a diagram of one example of a lubrication management system.

FIG. 2 is a diagram of a relational database forming part of the system shown in FIG. 1.

FIG. 3 is a table illustrating records in a lubrication table forming part of the database shown in FIG. 2.

FIG. 4 is a flowchart of an example of a process of lubrication management.

### DETAILED DESCRIPTION

A better understanding of various features and advantages of the present invention will be obtained by reference to the following detailed description of embodiments the invention and accompanying drawings, which set forth illustrative embodiments in which certain principles of the invention are utilized.

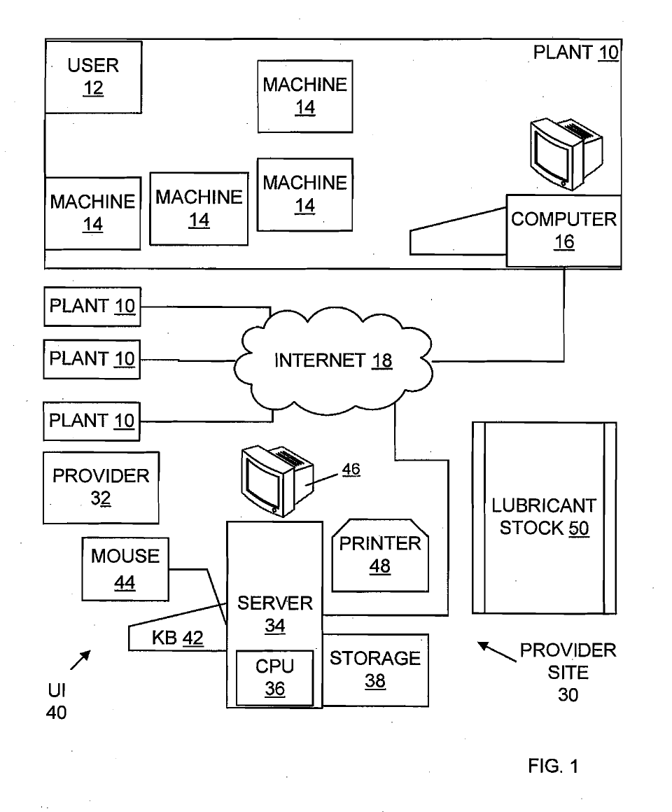

Referring to the accompanying drawings, and initially to FIG. 1, a plant 10 operated by a customer 12 contains one or more pieces of equipment 14 that require regular lubrication, and a client computer 16 connected to a communications network, such as the internet, 18. As shown in FIG. 1, there may be a plurality of plants 10, only one of which is shown in detail.

In general, the term “customer” is used herein to denote the operator of the equipment, who is the consumer and beneficiary of lubricants and lubrication maintenance services.

The client computer 16 may be a conventional general-purpose personal computer, having a central processing unit (CPU), program and data storage media, a customer interface such as a keyboard, mouse, and monitor, and an attached printer. The client computer may be loaded with an operating system and a web browser. All of those components are very well known and understood, and in the interests of conciseness are not further described here.

A provider site 30 operated by a provider 32 comprises a server computer 34 that is also connected to the internet 18. The server computer 34 comprises a CPU 36, program and data storage media 38, a user interface 40 comprising a keyboard 42, mouse 44, and monitor 46, and a printer 48. The provider 32 may also be a supplier of lubricants, in which case the provider site 30 may also include stocks 50 of lubricants.

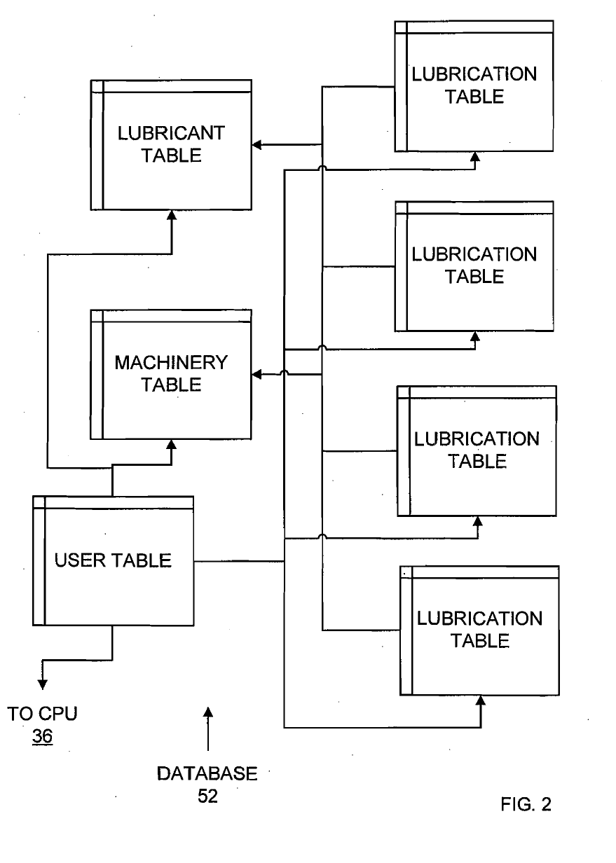

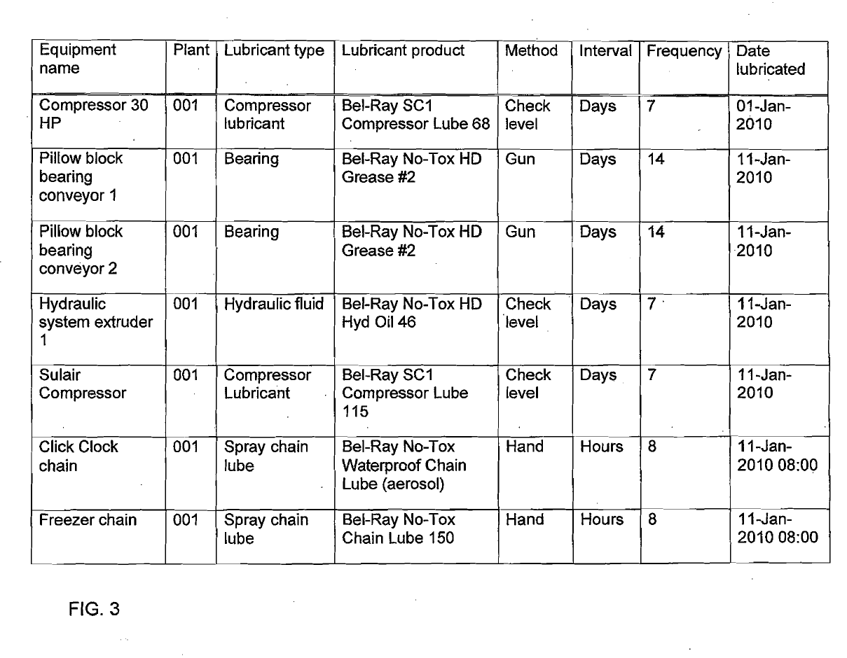

Referring now also to FIGS. 2 and 3, the server computer 34 has stored on the data storage media 38 a database 52. The database 52 may include one or more lubrication tables listing scheduled lubrications for specific equipment. The lubrication table may include one or more lubrication records. Each lubrication record in the lubrication table may specify: a plant 10; a piece of equipment 14; a lubricant (in this embodiment, a specific product); a method and/or location of lubrication; a frequency of lubrication; a date and/or time when the lubrication was last reported as being carried out; and a date and/or time when the lubrication is next due. The due date or time is calculated from the date or time of last lubrication and the frequency of lubrication. Therefore, it may not be necessary for both dates to be stored explicitly, because if one is stored the other can be generated on the fly when it is needed. The database 52 may also maintain a history of past lubrication events, for auditing purposes, either in the lubrication table or in a separate history table. In general, the term “lubrication” broadly includes all routine actions to ensure that the equipment 14 is properly lubricated. In particular, where the equipment includes an automatic lubricant dispenser with a reservoir for lubricant, “lubrication” may include inspecting the reservoir to determine whether it needs refilling, even if it does not.

Where a piece of equipment requires more than one sort of lubrication (for example, lubrication with different lubricants and/or different frequencies, and/or for different types of component, such as a chain and a bearing) the lubrication table may contain more than one record for the same piece of equipment. Where a piece of equipment requires more than one lubrication of the same sort (for example, where bearings are to be lubricated individually, but all with the same lubricant at the same frequency) the lubrication table may contain a single record for those lubrications. The record may then include additional information, such as the number and location of lubrication points involved. The record may also include a diagram, image or photograph, which may be handled as a Binary Large Object (BLOB), showing the location of lubrication points, especially when there are a large number and/or they are not conspicuous.

The database 52 may also include a lubricant table with information on specific lubricants, which may include at least some of the lubricants in the stocks 50. Each lubricant record in the lubricant table may include: a generic description of the type or properties of the lubricant; a product identifier, such as a name or number; a list of the forms and sizes of container of that lubricant that are available; and a list of appropriate methods of lubrication using that lubricant. The lubrication records may be related to the lubricant records so that the lubricant information in the lubrication records is consistent with or extracted from the lubricant records for the specified lubricant. Alternately, the lubrication record may include a relational link to the lubricant record such that the information on the lubricant in the lubrication record is “pulled” into or linked to the lubrication record.

The database 52 may also include one or more equipment tables with information on specific pieces of equipment that are commonly used by customers of the provider 32, which may include at least some of the information required for the lubrication records. The equipment records may be related to the lubricant records so that the lubricant information in the lubrication records is consistent with the specified type of equipment.

The database 52 may also include one or more user tables with user information for both customer 12 personnel and provider 32 personnel, including login names, passwords, contact details, and the records that each system user is allowed to access and/or change. Users may be profiled individually, or may be assigned to roles with standard sets of powers. For example, a user with a maintenance mechanic role may be allowed to read only his or her own user record, read the lubrication records for only a specific plant 10, and update the date of last lubrication and a remarks field in those records, but may not be allowed to access other records, nor to alter other fields in those records he or she can access. The right to add, delete, and modify other fields in lubrication records may be allowed to more senior customer personnel, or may be restricted to appropriate provider 32 personnel. The right to add, modify, or delete lubricant and equipment records, which are typically shared by all the plants 10 in the system, is in general restricted to appropriate provider 32 personnel. The management of users, user roles, and access rights in computer databases is well known and understood and in the interests of conciseness will not be further discussed here.

In operation, the database 52 is loaded with lubrication records for the relevant pieces of equipment in the plants 10. Those records are updated as necessary. The loading of lubrication records could be by manual input or through a electronic selection process where the user or the provider selects the type of equipment in the plant from a menu and the program automatically pulls the appropriate lubrication record from a database of records. At appropriate intervals, a member of customer 12 personnel using the web browser on client computer 16 accesses server computer 34 via the internet 18, and requests a report, either on-screen or printed, of currently due lubrication for all or a selection of the lubrication records for his or her plant 10. The report may be filtered by frequency. For example, a report of lubrication that is required daily, or less frequently, may be generated once a day, and a report of lubrication that is required more frequently than daily may be generated at a period corresponding to the most frequent lubrication. The member of customer personnel then reviews the report, carries out the lubrication tasks listed, and uses the client computer 16 to inform the server computer 34 that the lubrication has been done. For example, where a list of scheduled lubrication tasks is displayed on-screen in a web browser, an update button or link may be provided for each record, by which the customer personnel can update the date or time of last lubrication to the current date or time with a single mouse-click. It is also contemplated that the program may “push” reports to the customer, such as automated e-mail noticed of lubrication deadlines.

The server computer 34 then updates the database 52.

The server computer 34 may also estimate the amount of each lubricant used, and may compare the cumulative estimates with similar records of amounts supplied to or ordered by customer 12 from stocks 50. The estimates may be used to predict or anticipate future orders, or to verify that lubrication is being carried out correctly. An unusually high or low consumption of lubricants may indicate inappropriate lubrication practices or a defective piece of equipment. However, assessing quantities of lubricant to be applied is not an exact science, and the optimum quantities will vary from machine to machine and from plant to plant. It will therefore not always be possible to generate estimates sufficiently precise to be helpful.

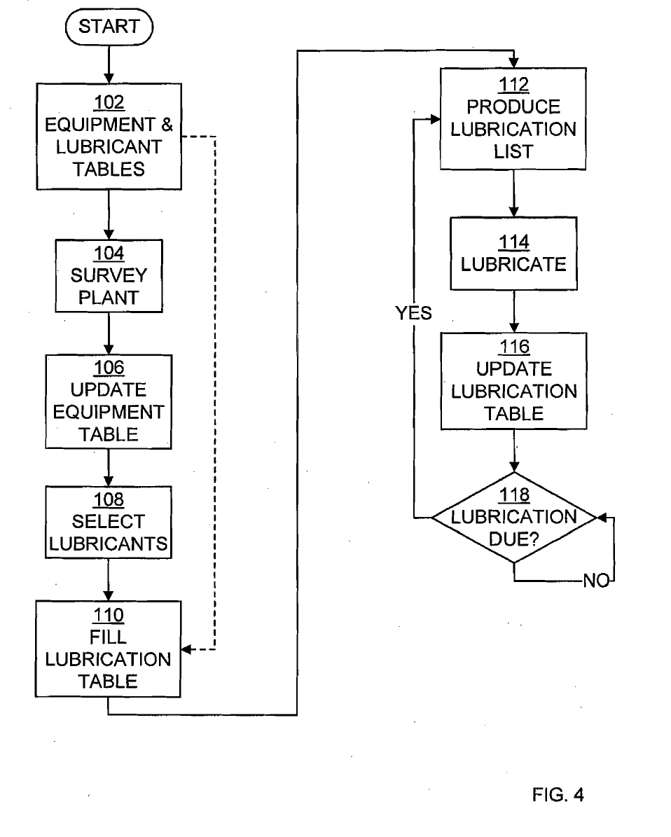

Referring now to FIG. 4, in an example of a method of lubrication management, in step 102 a database 52 including a populated equipment table and a populated lubricant table are provided. In step 104, a representative of provider 32 visits and surveys a customer plant 10. The representative compiles a list of pieces of equipment 14. Where a piece of equipment 14 is not already familiar to provider 32, the representative obtains particulars of the piece of equipment 14 and its lubrication requirements.

In step 104, entry of the information collected by the representative into the database 52 commences. The information may be entered by the representative, but it is presently preferred that the information be reviewed and entered by supervisory personnel at provider site 30.

In step 106, any new types of equipment 14 are entered into the equipment table. The information entered includes an identification for the equipment, and one or more records specifying types of lubrication required by type of lubricant, method and/or location of application, and frequency. The frequency may be specified by specifying a unit, for example, “days” or “hours,” and a multiplier, for example “1 day” or “7 days.” The unit may be useful in classifying time ranges, for example, when generating lubrication due reports. A photograph or diagram showing the locations of lubrication points may be stored as a BLOB to accompany one or more of the records. Step 106 may be bypassed if all pieces of equipment 14 at the plant 10 are of types already in the equipment table.

In step 108, each type of lubricant required for the new equipment 14 is matched to a specific product available from the stocks 50 of provider 32. That may be done by relating records in the equipment table with records in the lubricant table.

In step 110, the list of pieces of equipment 14 at the plant 10 is entered into the lubrication table, and appropriate lubrication records are generated by relating the pieces of equipment to the appropriate records in the equipment table. The lubrication records may be initialized by entering a date and/or time at which each lubrication was last carried out, or an arbitrary time, such as the present time.

When creating records in the database tables, the operator may be guided by menus of available options. The options on the menu may be limited to a greater or lesser extent on the basis of information already entered. For example, in step 108, a menu of lubricant products available from the stocks 50 of provider 32 may be displayed. Lubricant products inconsistent with the generic information already entered may be suppressed from the menu, for example, by being “grayed out” or omitted. That requires more work in creating the lubricant table and the user interface of the database, but reduces the work, and the risk of error, in entering individual pieces of equipment. Where more than one product is suitable, the equipment record may list more than one, and the final choice may be made when preparing the lubrication table in step 110. That may enable the list of lubricants used in plant 10 to be reduced, by selecting a lubricant suitable for more than one piece of equipment with overlapping requirements. That may also enable requirements of a specific plant 10 to be taken into consideration. For example, when compiling the lubrication table for a food-processing plant, non-food-grade lubricants may be suppressed from the final choice either manually or automatically.

In step 112, a maintenance person at plant 10 accesses the system and a list of scheduled lubrication is derived from the relevant lubrication table. The list may highlight maintenance that is significantly overdue, and may include lubrication that will become due before the next list is expected to be generated. The list may be generated and downloaded only when requested by the maintenance person, or may be generated at scheduled times. In the latter case, the schedule may be on the server 34, and the list may be pushed down from server 34 at the scheduled times. Alternatively, the client computer 16 may be programmed to poll the server 34 and pull down the list at the scheduled times. Where the connection between server 34 and client computer 16 is not continuously active, client computer 16 may be programmed to poll server 34 for a list of due or overdue scheduled lubrication whenever the client computer logs onto the server 34. The list may be printed on the printer of computer 16.

In step 114, the maintenance person carries out the lubrication that is due, and notes any issues that require to be reported.

In step 116, the maintenance person returns to client computer 16 and updates the relevant lubrication records in the lubrication table in database 52. That may involve merely displaying a screen listing the scheduled lubrication records and clicking on a button for each record, signaling to the server computer 34 to record that the lubrication was carried out at the current date and time. However, where that is not sufficiently precise, for example, when the time taken in step 114 to carry out all the lubrication on the schedule is a significant part of the interval between lubrications, the maintenance person may enter an actual time.

The maintenance person may also enter in a text comments field any issues noted in step 114. Comments may record, for example, the fact that and/or the time when routine adjustment to the actual lubrication was carried out; if and when additional lubrication was conducted; the general state and condition of the equipment 14; or specific problems that need to be corrected or monitored by the maintenance person at a future time or that require attention by other personnel. Depending on the nature of the comments expected or permitted in a particular system, the comments field may be routinely reviewed by the maintenance person or by other personnel at the plant 10 or the provider site 30, or may routinely be recorded, and reviewed only for auditing purposes or to investigate the history of a particular issue that has come to the attention of personnel for other reasons.

In step 118, the process waits until more lubrication is due, and then returns to step 112 to generate a new list of scheduled maintenance.

The process may at any time return to step 104 to update the list of equipment in the lubrication table, if the customer 12 notifies the provider 32 that the customer has added, removed, or altered one or more new pieces of equipment 16 at the plant 10. Steps 104 through 110 may then be confined to the changed piece or pieces of equipment 16. Alternatively, or in addition, the process may return to step 104 for periodic surveys of plant 10 to ensure that changes have not been overlooked.

When new types of lubricant become available, old types of lubricant are withdrawn, or recommendations or regulations for the use of specific lubricants are changed, the process may return to step 102 to update the lubricant table. The process may then proceed to step 110, where relevant parts of the lubrication tables may be updated to be consistent with the updated lubricant table. Where a change to the lubricant table renders an entry in the lubrication table invalid or improper, the need for a correction can be detected and signaled to an appropriate operative automatically. Procedures for detecting and alerting such errors are well known in general and, in the interests of consistency, will not be discussed here.

It is also contemplated that the system can provide a customer with alternative choices of lubricants and information as to the benefits for selecting a certain type of lubricant. For example, the system may identify that the selection of a better lubricant can extend the date for the next lubrication.

It is also contemplated that the system may be tied into an ordering system, permitting the customer to order or the provider to automatically ship necessary supplies of lubricants at prescribed times.

The preceding description of the presently contemplated best mode of practicing the invention is not to be taken in a limiting sense, but is made merely for the purpose of describing the general principles of the invention. Variations are possible from the specific embodiments described without departing from the scope and spirit of the invention as defined in the attached claims. For example, although a system using relational database tables has been described in detail, those skilled in the art will understand how other forms of database structure may be used. Where the same information appears in related tables or otherwise in more than one place within the logical structure of a database, those skilled in the art will understand the advantages and disadvantages of copying or linking specific data, and will be able to choose the appropriate arrangement for a particular implementation.

For example, although a system using a web browser on client computer 16 has been described, other forms of client software may be used where the need for special functionality or the desire for security outweighs the convenience and economy of a conventional, widely and cheaply available, web browser.

The full scope of the invention should be determined with reference to the Claims.

What is claimed is:

1. A method of managing lubrication of equipment, comprising:
storing on a computer-readable storage medium particulars of equipment requiring lubrication, wherein the particulars include at least a desired frequency of scheduled lubrication;
providing through use of a computer and the stored particulars a report of scheduled lubrication due for a particular equipment;
receiving by the computer information of a specific lubrication that has been carried out; and
updating the stored particulars to include at least one of when said specific lubrication was carried out and when said specific lubrication is next due in accordance with said desired frequency.

2. A method according to claim 1, further comprising storing said particulars for each of a plurality of pieces of equipment.

3. A method according to claim 1, further comprising storing said particulars for a plurality of different scheduled lubrications for a piece of equipment.

4. A method according to claim 1, wherein for each scheduled lubrication said stored particulars further include at least: an identification of a piece of equipment; a lubricant to be applied; and a method of lubrication.

5. A method according to claim 1, further comprising surveying equipment at a customer location, collecting at least some of said particulars of said equipment at said customer location, and including said collected particulars in said stored particulars.

6. A method according to claim 1, wherein providing said report comprises permitting a customer to access said computer over the internet and obtain said report.

7. A computer-readable storage medium carrying computer-readable instructions to cause a suitable general-purpose computer to carry out a method of managing lubrication of equipment, the method comprising:
storing on a computer-readable storage medium particulars of equipment requiring lubrication, wherein the particulars include at least a desired frequency of scheduled lubrication;
providing through use of a computer and the stored particulars a report of scheduled lubrication due for a particular equipment;
receiving by the computer information of a specific lubrication that has been carried out; and
updating the stored particulars to include at least one of when said specific lubrication was carried out and when said specific lubrication is next due in accordance with said desired frequency.

8. A system for managing lubrication of equipment, comprising a server computer programmed to carry out a method of managing lubrication of equipment, the method comprising:
storing on a computer-readable storage medium particulars of equipment requiring lubrication, wherein the particulars include at least a desired frequency of scheduled lubrication;
providing through use of a computer and the stored particulars a report of scheduled lubrication due for a particular equipment;
receiving by the computer information of a specific lubrication that has been carried out; and
updating the stored particulars to include at least one of when said specific lubrication was carried out and when said specific lubrication is next due in accordance with said desired frequency.

9. A system according to claim 8, wherein said server computer is remote from said equipment, further comprising a client computer at a location with said equipment in communication with said server computer to receive said report.

10. A system according to claim 9, comprising a plurality of said client computers at respective locations with said equipment, and wherein said server computer is operative to provide each said client computer with said reports relating only to equipment at the respective said location.

11. A method of managing lubrication of equipment, comprising:
accessing a remote computer that comprises a database of particulars of equipment requiring lubrication, wherein the particulars include at least a desired frequency of scheduled lubrication;
obtaining from the remote computer a report of scheduled lubrication due to said equipment;
carrying out said lubrication on said equipment; and
inputting to said remote computer information of a specific lubrication carried out.

12. A method according to claim 11, further comprising obtaining said report for, lubricating, and inputting said information of lubrication carried out for a plurality of pieces of equipment.

13. A method according to claim 11, further comprising obtaining said report for a plurality of different scheduled lubrications for at least one piece of equipment.

14. A method according to claim 11, wherein for each scheduled lubrication said report further includes at least: an identification of a piece of equipment; a lubricant to be applied; and a method of lubrication.

15. A method according to claim 11, further comprising surveying equipment at a customer location, collecting said particulars of said equipment at said customer location, and providing said collected particulars to said remote computer.
